(19) United States
(12) Patent Application Publication
(10) Pub. No.: US 2014/0277717 A1
(43) Pub. Date: Sep. 18, 2014

(54) MULTI-AXIS CONFIGURABLE FIXTURE

(71) Applicant: PaR Systems, Inc., Shoreview, MN (US)

(72) Inventor: Thomas E. Jung, Welch, MN (US)

(21) Appl. No.: 14/213,398

(22) Filed: Mar. 14, 2014

Related U.S. Application Data
(60) Provisional application No. 61/798,047, filed on Mar. 15, 2013.
(60) Provisional application No. 61/940,827, filed on Feb. 17, 2014.

(51) Int. Cl. B25J 9/16; B25J 9/00

(52) U.S. Cl. CPC B25J 9/1682; B25J 9/0084
USPC 700/248

(57) ABSTRACT

A holding assembly and a method of holding a workpiece are provided. The assembly and method include a plurality of multi-degree of freedom robotic devices, each device having a workpiece engaging device to hold a workpiece wherein and each robotic device is configured to move the corresponding workpiece engaging device to a desired position based on the workpiece to be held. A controller is operably connected to each of the freedom robotic devices to control each of multi-degree of freedom robotic devices so as to move the corresponding workpiece engaging device to a desired position based on the workpiece to be held.

### CROSS REFERENCE TO RELATED APPLICATION

This application claims the benefit of U.S. Provisional Applications entitled “MULTI-AXIS SELF ADJUSTING FLEXIBLE FIXTURE” having Ser. No. 61/798,047, and filed Mar. 15, 2013 and entitled “MULTI-AXIS CONFIGURABLE FIXTURE” having Ser. No. 61/940,827, and filed Feb. 17, 2014, the contents of both of which are also incorporated herein by reference in their entirety.

### BACKGROUND

The discussion below is merely provided for general background information and is not intended to be used as an aid in determining the scope of the claimed subject matter.

Support assemblies for individual workpieces are generally known. However, precision machining, inspection or performing other operations on an elongated workpiece is particularly difficult. In many instances, the elongated workpiece is not rigid enough when suspended from its ends and therefore is susceptible to lateral and/or twisting movements. Although various fixtures can be used to control such movement and restrain the elongated workpiece, such fixtures often are suited for an individual part, requiring unique fixture tooling for each individual part. Other types of fixtures include flexibility allowing different parts to be supported with the same fixture. However, improved configurable fixtures are always needed.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

A holding assembly and a method of holding a workpiece are provided. The system and method include a plurality of multi-degree of freedom robotic devices, each device having a workpiece engaging device to hold a workpiece wherein and each robotic device is configured to move the corresponding workpiece engaging device to a desired position based on the workpiece to be held. A controller is operably connected to each of the freedom robotic devices to control each of multi-degree of freedom robotic devices so as to move the corresponding workpiece engaging device to a desired position based on the workpiece to be held. In a particularly useful embodiment, the multi-degree of freedom robotic devices each comprises a robotic arm. The workpiece engaging devices can be removable and/or adjustable in one or more degrees of freedom of movement to hold a desired workpiece, thereby increasing the flexibility of the assembly.

In a further embodiment, the controller can access configuration information pertaining to each workpiece to be held. In a particularly advantageous embodiment, the controller is configured to control each multi-degree of freedom robotic device of a first plurality of multi-degree of freedom robotic devices to a desired position to hold a first workpiece and configured to control each multi-degree of freedom robotic device of a second plurality of multi-degree of freedom robotic devices to a desired position to hold a second workpiece, and wherein the first plurality of multi-degree of freedom robotic devices and the second plurality of multi-degree of freedom robotic devices are configured or spaced apart so as to allow the first workpiece to be removed while a system performs work on the second workpiece. In this manner, processing of workpieces can be increased.

### BRIEF DESCRIPTION OF THE DRAWINGS

FIG. 1 is a side view of a gantry system

FIG. 2 is a perspective view of a multi-axis configurable fixture holding assembly and schematic illustration of control environment

FIG. 3 is an illustration of a multi-axis robotic arm

FIG. 4 is a perspective view of end effectors for holding a workpiece

FIG. 5 is a perspective view of an end effector

FIG. 6 is a top view of a multi-axis configurable fixture holding assembly mounted inside the gantry of FIG. 1

FIG. 7 is a schematic illustration of a computing environment

### DETAILED DESCRIPTION OF THE ILLUSTRATIVE EMBODIMENTS

In FIG. 1, a gantry or positioning system is illustrated at 11. The gantry system 11 includes a structure 13 having rails 11A (see also FIG. 6). In the exemplary embodiment, rails 11A are elevated, being supported by supports 16. Bridge 10 supports at least one mast 12. In the embodiment illustrated, mast 12A is adapted to hold an end effector 15 such as a water jet cutter or other work device for performing work on a workpiece supported by a fixture or holding assembly 17 (FIG. 2). It should be understood that the gantry system 11 is but one embodiment of a positioning system, the details of which should not be considered limiting to aspects of the invention herein described. For purposes of aspects of the present invention, the positioning system can take any form such as but not limited to other robotic positioning systems including fixed or movable robotic systems, for example, a robotic arm.

As illustrated in FIG. 2, a configurable fixture holding assembly 17 (herein referred to as “holding assembly”) typically comprises a plurality of support assemblies 19, each support assembly is configured to engage a portion of a workpiece 18. In general, as an advantageous embodiment of the invention, the holding assembly 17 includes a plurality of spaced apart multi-axis robotic devices 20, by example herein as arms. The multi-axis robotic arms 20 are held stationary (during use while holding a workpiece) and, if desired can be mounted to part support structure 13, herein by example a rail, wherein in an advantageous embodiment at least some of the multi-axis robotic arms 20 can be moved and fixed to selected locations as desired using suitable clamps or fastening members. The configurable fixture holding assembly 17 is well adapted to support workpieces with high curvature such as cylindrically shaped or conical shaped objects, such as portions of an aircraft fuselage. As is well known, the fuselage of an aircraft can vary significantly along its longitudinal length. The configurable fixture holding assembly 17 is particularly well adapted to hold a wide variety of different chord lengths. Note that in other cases, the number of robots, relative space configuration, spacing, e.g. in one, two or three dimensions on support structure 13 and/or the holding capacity of the robot device may all vary depending on the fixturing requirements. A support structure 13 for supporting robotic devices in two dimensions can comprise multiple fixed or adjustable rails and/or a planar structure. Fixed or adjustable vertical supports can used as desired or if needed to increase the height of a robotic device. The robotic devices can be added or taken out if needed.

In one embodiment, the holding assembly 17 further includes a system controller 60 operably coupled to each of the multi-axis robotic arms 20 and workpiece engaging device 22, if desired, to position and control operation of each of the multi-axis robotic arms 20 and corresponding workpiece engaging device 22, if desired, of the holding assembly 17. Providing workpiece engaging devices also with one or more degrees of freedom can be advantageous in accurately holding the workpiece as desired. Referring to FIG. 5, in the embodiment illustrated each of the workpiece engaging devices 22 include individual vacuum generator supported cups 24 along with configurable tooling balls that are mounted upon a friction settable coupling. In the exemplary workpiece engaging device illustrated, a tooling ball 26 remains stationary while adjustable tooling balls 28 move as indicated by arrow 29 to adapt to the workpiece. This planar movement of tooling balls 28 can provide a seventh degree of freedom although it should be notes that the workpiece engaging device can be configured so as to provide one or more other forms of freedom of degrees of movement. The workpiece engaging device 22 can be a replaceable device on the robotic device where the workpiece engaging device 22 is configured to hold a particular workpiece when mounted on the robotic device, or configurable, i.e. adjustable, to hold a plurality of different workpieces.

The holding assembly 17 can be used to hold a plurality of different workpieces by simply commanding each of the multi-axis robotic arms 20 and corresponding workpiece engaging device 22, if desired, to obtain a selected position such that together each of the workpiece engaging devices 22 hold a different portion of the workpiece in a selected position. The position of each multi-axis robotic arm 20 and corresponding workpiece engaging device 22 can be obtained in a suitable manner such as where each is determined from a model of the workpiece, typically on a on a computer readable memory, either internal or external, but otherwise made accessible to controller 60 or other computing device where the positions are calculated or determined. Ascertaining the position of each multi-axis robotic arm 20 and corresponding workpiece engaging device 22 is not part of the present invention.

Referring to FIGS. 2, 4, 5, and 6, the system controller 60 can be configured to download configuration information such as a file or the like for a workpiece to be held by the holding assembly 17 when the system operator scans a bar code for a workpiece to be processed, or otherwise enters the workpiece information into the controller 60. After which, the controller 60 then provides control signals to each of the multi-axis robotic arms as needed to hold the workpiece as desired.

Referring to FIG. 3, the multi-axis robotic arm 20 is illustrated. In this embodiment, the robotic arm 20 comprises joints that allow for six degrees of freedom, which allows the robotic device to be configurable anywhere and as necessary in a large work envelope, but this should not be considered limiting to aspects of the invention herein described.

As illustrated in FIG. 4, the exemplary workpiece engaging device 22 illustrated herein in general includes tooling balls or projections and vacuum cups that contact workpiece 18. The holding assembly 17 is operably coupled to the controller 60 to receive command signals from the controller 60 to automatically move each multi-axis robotic arm (and workpiece engaging device 22, if desired) in multiple degrees of freedom to adjust to the workpiece. If desired, each workpiece engaging device can be manually adjusted or controlled by a suitable controller. One or more of the workpiece engaging devices can be adjustable with respect to one or more degrees of freedom of movement. Except as described herein, the type of workpiece engaging device is not relevant to the present invention.

Before or after installing and/or adjusting each workpiece adjusting device 22, the articulated robotic arm will move to its commanded position to await part loading. Alignment checking devices such as but not limited to laser detectors or the like can be used to verify and/or assist the operator in obtaining proper alignment. The workpiece can then be installed on the workpiece engaging devices manually or with the aid of the positioning system 11 or other supporting device. With the workpiece now properly positioned on the holding assembly 17, workpiece engaging system 62 can engage end effector 15 on mast and machine, inspect, or perform other forms of work on the workpiece.

Referring to FIG. 5, in the embodiment illustrated each of the workpiece engaging devices 22 include individual vacuum generator supported cups 24 along with configurable tooling balls that are mounted upon a friction settable coupling. A tooling ball 26 remains stationary while adjustable tooling balls 28 move to adapt to the workpiece. This planar movement of tooling balls 28 can provide the seventh degree of freedom.

As illustrated in FIG. 6, the holding assembly 17 can be programmed to fixture multiple workpieces simultaneously. In this embodiment, holding assembly 17 fixtures three workpieces 18A, 18B, and 18C. In such a system, the controller is configured to control each multi-degree of freedom robotic device of a first plurality of multi-degree of freedom robotic devices to a desired position to hold the first workpiece 18A, and configured to control each multi-degree of freedom robotic device of a second plurality of multi-degree of freedom robotic devices to a desired position to hold the second workpiece 18B, and configured to control each multi-degree of freedom robotic device of a second plurality of multi-degree of freedom robotic devices to a desired position to hold the second workpiece 18B. The system thus offers great flexibility as all the robotic devices can either jointly fixture one workpiece for the longest workpieces, or groups of robots can fixture more than workpiece at the same time. The latter of which is also advantageous because it allows an operator to remove a workpiece where the desired work has been completed, while the positioning system 11 continues performing work on another workpiece held by another group of robotic devices. It is even be possible to have each of the robot arms fixture one part/assembly and thus, the number of robotic arms is only limited to how many individual workpieces can be fixtured by the holding assembly 17.

Referring to FIG. 7, the system controller 60 and/or workpiece engaging system 62 each can be implemented on a digital and/or analog computer. FIG. 7 and the related discussion provide a brief, general description of a suitable computing environment in which the system controller 60 and/or workpiece engaging system 62 may each be implemented. Although not required, the system controller 60 and/or workpiece engaging system 62 can be implemented at least in part, in the general context of computer-executable instructions, such as program modules, being executed by a computer 70. Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, and the like. Aspects of the invention may also be practiced in distributed computing environments where tasks are performed by remote processing devices that are linked through a communications network. In a distributed computer environment, program modules may be located in both local and remote memory storage devices.

The computer 70 illustrated in FIG. 7 comprises a conventional computer having a central processing unit (CPU) 72, memory 74 and a system bus 76, which couples various system components, including memory 74 to the CPU 72. The system bus 76 may be any of several types of bus structures including a memory bus or a memory controller, a peripheral bus, and a local bus using any of a variety of bus architectures. The memory 74 includes read only memory (ROM) and random access memory (RAM). A basic input/output (BIOS) containing the basic routine that helps to transfer information between elements within the computer 70, such as during start-up, is stored in ROM. Storage devices 78, such as a hard disk, a floppy disk drive, an optical disk drive, etc., are coupled to the system bus 76 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 74 from at least one of the storage devices 78 with or without accompanying data.

Input devices such as a keyboard 80 and/or pointing device (mouse) 82, or the like, allow the user to provide commands to the computer 70. A monitor 84 or other type of output device is further connected to the system bus 76 via a suitable interface and provides feedback to the user. If the monitor 84 is a touch screen, the pointing device 82 can be incorporated therewith. The monitor 84 and typically an input pointing device 82 such as mouse together with corresponding software drivers form a graphical user interface (GUI) 86 for computer 70. Interfaces 88 on each of the system controller 60 and/or workpiece engaging system 62 allow communication between system controller 60 and/or workpiece engaging system 62. Interfaces 88 also represent circuitry used to send signals to or receive signals to the multi-axis robotic arms and/or end effectors mentioned above. Commonly, such circuitry comprises digital-to-analog (D/A) and analog-to-digital (A/D) converters as is well known in the art. Functions of system controller 60 and/or workpiece engaging system 62 can be combined into one computer system. In another computing environment, each of the system controller 60 and/or workpiece engaging system 62 is a single board computer operable on a network bus of another computer, such as a supervisory computer. The schematic diagrams of FIGS. 6 and 7 are intended to generally represent these and other suitable computing environments.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

What is claimed is:

1. A holding assembly comprising:
a plurality of multi-degree of freedom robotic devices, each device having a workpiece engaging device to hold a workpiece wherein and each robotic device is configured to move the corresponding workpiece engaging device to a desired position based on the workpiece to be held; and
a controller operably connected to each of the freedom robotic devices to control each of multi-degree of freedom robotic devices so as to move the corresponding workpiece engaging device to a desired position based on the workpiece to be held.

2. The holding assembly of claim 1 wherein the controller accesses configuration information pertaining to each workpiece to be held.

3. The holding assembly of claim 1 and further comprising a support structure connected to and supporting at least some of the multi-degree of freedom robotic devices.

4. The holding assembly of claim 3 wherein at least some of the multi-degree of freedom robotic devices are movable on the support structure.

5. The holding assembly of claim 4 wherein the support structure comprises a rail.

6. The holding assembly of claim 1 wherein the multi-degree of freedom robotic devices each comprises a robotic arm.

7. The holding assembly of claim 1 and further wherein each workpiece engaging device is replaceable.

8. The holding assembly of claim 8 wherein the workpiece engaging device is adjustable in one or more degrees of freedom of movement to hold a desired workpiece.

9. The holding assembly of claim 1 wherein the controller is configured to control each multi-degree of freedom robotic device of a first plurality of multi-degree of freedom robotic devices to a desired position to hold a first workpiece and configured to control each multi-degree of freedom robotic device of a second plurality of multi-degree of freedom robotic devices to a desired position to hold a second workpiece, and wherein the first plurality of multi-degree of freedom robotic devices and the second plurality of multi-degree of freedom robotic devices are configured so as to allow the first workpiece to be removed while a system performs work on the second workpiece.

10. A method for holding a workpiece comprising:
supporting a plurality of multi-degree of freedom robotic devices, each device having a workpiece engaging device to hold a workpiece; and
controlling each of multi-degree of freedom robotic devices so as to move the corresponding workpiece engaging device to a desired position based on the workpiece to be held.

11. The method of claim 10 and further comprising accessing configuration information pertaining to each workpiece to be held and wherein controlling comprises controlling each of multi-degree of freedom robotic devices so as to move the corresponding workpiece engaging device to the desired position based on the workpiece to be held based on the configuration information.

12. The method of claim 10 wherein supporting the plurality of multi-degree of freedom robotic device includes using a support structure connected to and supporting the multi-degree of freedom robotic devices.

13. The method of claim 12 wherein at least some of the multi-degree of freedom robotic devices are movable on the support structure.

14. The method of claim 13 wherein the support structure comprises a rail.

15. The method of claim 10 wherein the multi-degree of freedom robotic devices each comprises a robotic arm.

16. The method of claim 10 and each of the plurality of multi-degree of freedom robotic devices includes an adjustable workpiece engaging device with respect to one or more degrees of freedom of movement and wherein the method further comprise adjusting each of the workpiece engaging devices.

17. The method of claim 10 wherein controlling comprises controlling each multi-degree of freedom robotic device of a first plurality of multi-degree of freedom robotic devices to a desired position to hold a first workpiece and controlling each multi-degree of freedom robotic device of a second plurality of multi-degree of freedom robotic devices to a desired position to hold a second workpiece.

18. The method of claim 17 wherein supporting the multi-degree of freedom robotic devices comprises supporting the multi-degree of freedom robotic devices so as to allow the first workpiece to be removed while a system performs work on the second workpiece.
